(19) United States
(12) Patent Application Publication
(10) Pub. No.: US 2012/0224935 A1
(43) Pub. Date: Sep. 6, 2012

(54) FLOATING FASTENER

(76) Inventor: Ming-Chung CHIU, New Taipei City (TW)

(21) Appl. No.: 13/040,876

(22) Filed: Mar. 4, 2011

(51) Int. Cl. F16B 21/00

(52) U.S. Cl. 411/352

(57) ABSTRACT

A floating fastener includes a mounting socket bonded to a first plate member and having a beveled top mounting flange, a cap member axially slidably coupled to the mounting socket, an expandable stop ring mounted in a locating groove in the bottom side of the cap member to facilitate coupling of the cap member to the mounting socket and to prohibit the cap member from moving upwardly over the top mounting flange of the mounting socket, a locking member affixed to the cap member for fastening to a second plate member to lock the first and second plate members together, and a spring member sleeved onto the locking member and stopped between the head of the locking member and a shoulder in the mounting socket.

### BACKGROUND OF THE INVENTION

1. Field of the Invention

The present invention relates to fasteners for joining metal plate members and more particularly, to a floating fastener consisting of a mounting socket, an expandable stop ring, a locking member and a spring member, which facilitates mounting, assures mounting stability, and avoids component deformation or breaking during mounting.

2. Description of the Related Art

When fastening plate members together, positioning screws that are each formed of a knob, a ring and a screw nail are usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. Subject to detachable plate member mounting techniques, maintenance or repair of the power drive, or adjustment of the speed-adjustment unit can be performed conveniently. However, during a plate member mounting or dismounting operation, the screw nails may be lost accidentally, causing installation problems.

To facilitate detachable installation and to avoid missing component parts, floating captive screws are created. A floating captive screw is known consisting of a cap member, a lock screw and a mounting socket. During application, the mounting socket is bonded to a through hole on a first plate member, and the lock screw is threaded into a screw hole on a second plate member to lock the first and second plate members together. When unfastened the lock screw from the screw hole of the second plate member for allowing removal of the first plate member from the second plate member, the floating captive screw is kept secured to the first plate member, avoiding falling or missing.

FIGS. 8 and 9 illustrate a floating captive screw according to the prior art. According to this design, the floating captive screw comprises a mounting socket A having a bottom bonding end A1 bonded to a plate member B, a lock screw C1 floating in a chamber A0 in the mounting socket A, a spring member C11 sleeved onto the lock screw C1 and stopped between a shoulder A3 inside the mounting socket A and the head of the lock screw C1, and a cap member C fixedly fastened to the head of the lock screw C1. The mounting socket A has a top coupling flange A2 protruded from the periphery of the top side. The cap member C has longitudinal crevices C2 extending to the bottom side, and a bottom coupling flange C3 protruded from the inner bottom side and axially slidably coupled to the periphery of the mounting socket A for allowing axial movement of the cap member C with the lock screw C1 relative to the mounting socket A.

This design of floating captive screw still has drawbacks as follows:

1. When inserting the lock screw C1 into the mounting socket A and vertically downwardly attaching the cap member C to the mounting socket A to force the bottom coupling flange C3 over the top coupling flange A2, the spring member C11 will be compressed to impart a reaction force to the cap member C, and the cap member C may be forced to bias the mounting socket A relative to the plate member B, causing mounting socket loosening or disconnection.

2. When forcing the bottom coupling flange C3 over the top coupling flange A2 during the assembly process, the bottom coupling flange C3 will be forced to expand. At this time, the bottom edge of the cap member C may be forced to deform permanently or to break, causing installation failure.

3. The design of the longitudinal crevices C2 to enhance expandability of the bottom coupling flange C3 lowers the structural strength of the cap member C.

Therefore, it is desirable to provide a floating fastener that eliminates the drawbacks of the aforesaid prior art design.

### SUMMARY OF THE INVENTION

The present invention has been accomplished under the circumstances in view. It is therefore an object of the present invention to provide a floating fastener, which facilitates mounting, assures mounting stability, and avoids component deformation or breaking during mounting.

To achieve this and other objects of the present invention, a floating fastener comprises a mounting socket, which comprises a top mounting flange extending around the periphery of the top side thereof, a bottom mounting unit bonded to a first plate member and a shoulder defined in the bottom mounting unit, a cap member, which is axially slidably coupled to the mounting socket and comprises a bottom-open accommodation chamber having a bottom open side, a coupling hole cut through the top wall thereof in communication with the bottom-open accommodation chamber and a locating groove extending around an inside wall thereof near the bottom open side of the bottom-open accommodation chamber, an expandable stop ring mounted in the locating groove of the cap member to facilitate coupling of the cap member to the mounting socket without causing cap member damage, a locking member, which comprises a head, a tool-driving block upwardly protruded from the head and fixedly mounted in the coupling hole of the cap member and a fastening shank downwardly extended from the head and adapted for fastening to the second plate member to lock the first plate member to the second plate member, and a spring member sleeved onto the locking member and stopped between the head of the locking member and the shoulder of the mounting socket.

Further, the expandable stop ring can be a C-shaped retaining ring. Subject to the arrangement of the expandable stop ring in the locating groove of the cap member, it is not necessary to make any longitudinal crevices on the cap member to facilitate mounting, the structural strength of the cap member is maintained intact, avoiding deformation.

### BRIEF DESCRIPTION OF THE DRAWINGS

FIG. 1 is an elevational view of a floating fastener in accordance with the present invention.

FIG. 2 is an exploded view of the floating fastener in accordance with the present invention.

FIG. 3 is a sectional exploded view of the floating fastener in accordance with the present invention.

FIG. 4 is a schematic sectional assembly view of the floating fastener in accordance with present invention (I).

FIG. 5 is a schematic sectional assembly view of the floating fastener in accordance with present invention (II).

FIG. 6 is a schematic sectional view illustrating an installation operation of the floating fastener in accordance with the present invention (I).

FIG. 7 is a schematic sectional view illustrating an installation operation of the floating fastener in accordance with the present invention (II).

FIG. 8 is a sectional applied view of a floating captive screw according to the prior art (I).

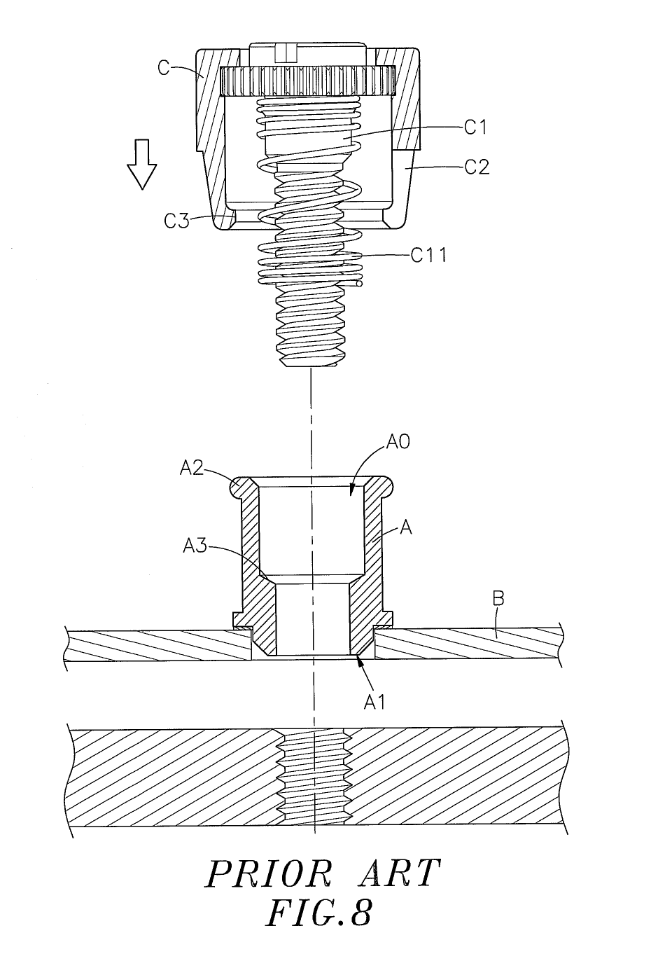

FIG. 9 is a sectional applied view of a floating captive screw according to the prior art (II).

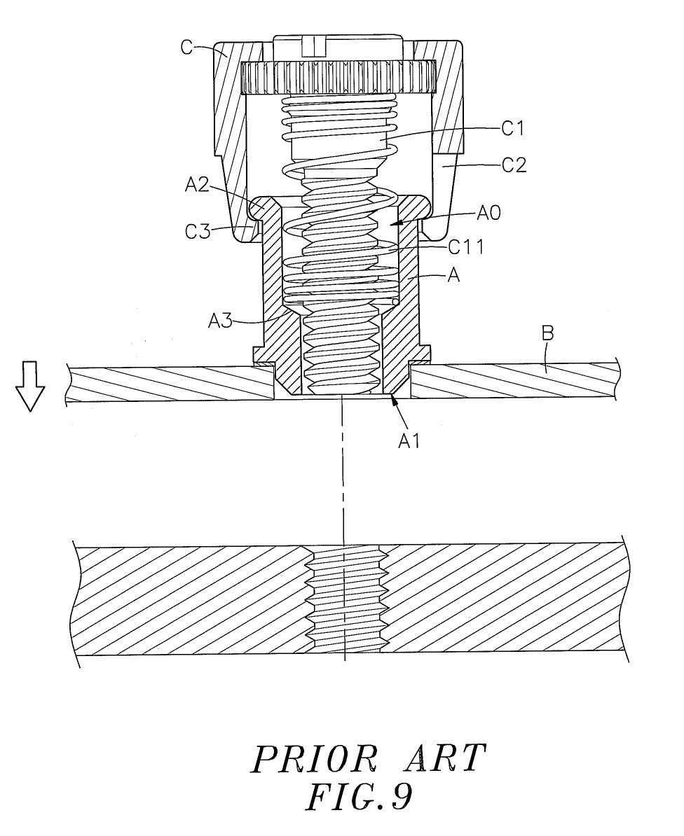

### DETAILED DESCRIPTION OF THE PREFERRED EMBODIMENT

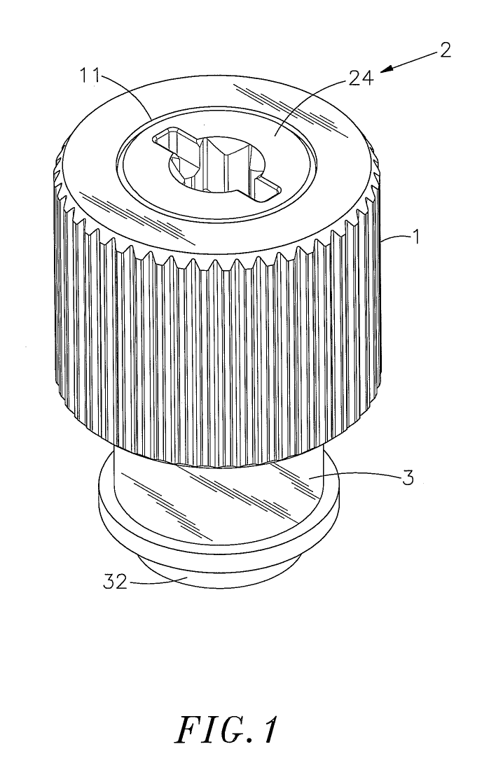

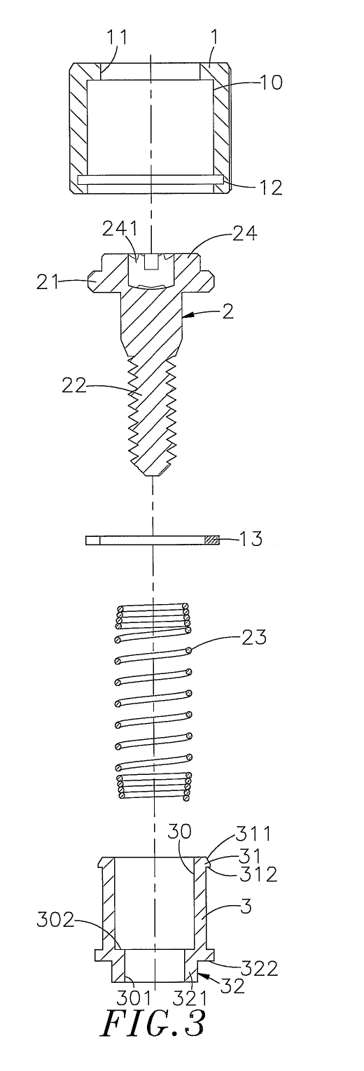

Referring to FIGS. 1-3, a floating fastener in accordance with the present invention is shown comprising a cap member 1, a locking member 2, an expandable stop ring 13, a spring member 23 and a mounting socket 3.

The cap member 1 has defined therein a bottom-open accommodation chamber 10, a coupling hole 11 cut through the top wall thereof in communication with the bottom-open accommodation chamber 10, and a locating groove 12 extending around the inside wall near the bottom open side of the bottom-open accommodation chamber 10 for accommodating the expandable stop ring 13.

The locking member 2 has a head 21, a tool-driving block 24 upwardly protruded from the top wall of the head 21, a tool groove 241 located on the tool-driving block 24, an engagement portion 211 extending around the periphery of the head 21, and a fastening shank (for example, threaded shank) 22 perpendicularly downwardly extending from the bottom side of the head 21. The engagement portion 211 can be formed of multiple teeth, ribs or raised spots.

The mounting socket 3 has defined therein an open chamber 30, a top mounting flange 31 extending around the periphery of the top side thereof that has a beveled top edge 311 and a horizontal bottom edge 312, and a bottom mounting unit 32 located on the bottom side thereof. The bottom mounting unit 32 comprises a horizontal bonding wall 322, a tubular neck 321 axially forwardly extended from the bottom side of the horizontal bonding wall 322, a through hole 301 defined in the tubular neck 321 in communication with the open chamber 30, and a shoulder 302 suspending in the bottom side of the open chamber 30,

The spring member 23 is sleeved onto the fastening shank 22 of the locking member 2 and stopped between the head 21 of the locking member 2 and the shoulder 302 of the mounting socket 3.

When assembling the component parts of the floating fastener, mount the expandable stop ring 13 in the locating groove 12 of the cap member 1, and then insert the head 21 of the locking member 2 into the bottom-open accommodation chamber 10 of the cap member 1 to press-fit the tool-driving block 24 into the coupling hole 11 of the cap member 1 and to force the toothed engagement portion 211 of the locking member 2 into friction engagement with the inside wall of the cap member 1, and then sleeve the spring member 23 onto the fastening shank 22 of the locking member 2, and then insert the locking member 2 and the spring member 23 into the open-chamber 30 of the mounting socket 3 to stop the spring member 23 against the shoulder 302 and to force the expandable stop ring 13 over the beveled top edge 311 of the top mounting flange 31 of the mounting socket 3. When released the hand from the cap member 1, the spring member 23 pushes the locking member 2 and the cap member 1 outwards relative to the mounting socket 3, enabling the expandable stop ring 13 to be stopped at the horizontal bottom edge 312 of the top mounting flange 31 of the mounting socket 3, and therefore the locking member 2 and the cap member 1 are axially movably secured to the mounting socket 3, and the spring member 23 is kept in between the cap member 1 and the mounting socket 3.

Further, the aforesaid expandable stop ring 13 can be, for example, a C-shaped retainer ring; the locking member 2 can be a lock screw or lock pin; the tool-driving block 24 can be a hexagonal block or any other polygonal block fitting the configuration of the coupling hole 11 of the cap member 1; the tool groove 241 can be Phillips groove, keystone groove, asterisk groove, hex groove, or any other design of tool groove for driving by a Phillips-tip screwdriver, keystone-tip screwdriver, asterisk-tip screwdriver, hex-tip screwdriver, or any other matching design tool.

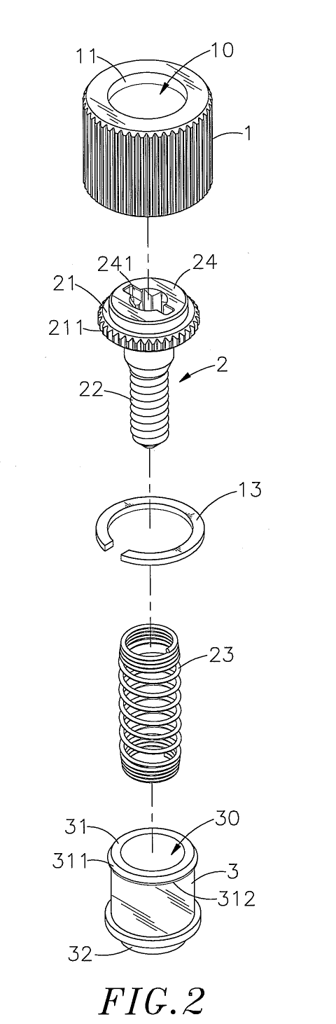

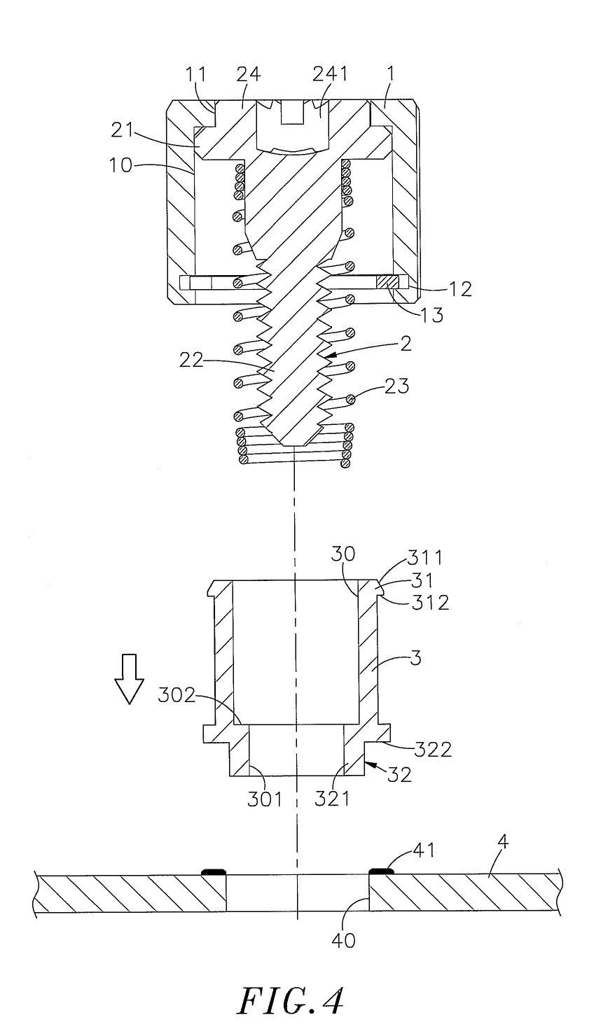

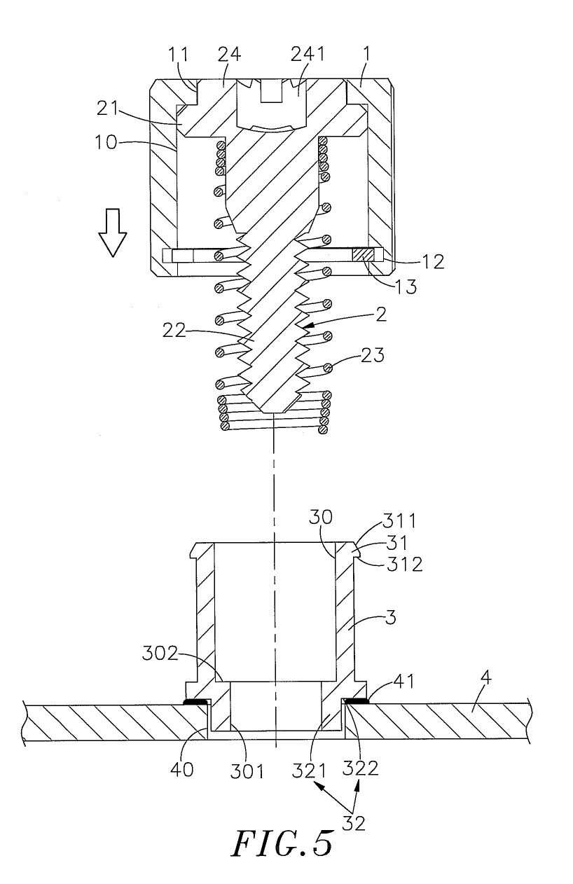

Referring to FIGS. 4 and 5 and FIGS. 2 and 3 again, during application of the floating fastener, insert the tubular neck 321 of the bottom mounting unit 32 comprises a horizontal bonding wall 322 of the mounting socket 3 into a mounting through hole 40 on a first plate member 4, enabling the horizontal bonding wall 322 of the bottom mounting unit 32 to be stopped at a solder material 41 the top surface of the first plate member 4 around the mounting through hole 40. Thereafter, apply a reflow soldering technique to bond the mounting socket 3 to the first plate member 4.

After bonding the mounting socket 3 and the first plate member 4, fasten the head 21 of the locking member 2 to the coupling hole 11 of the cap member 1 and mount the expandable stop ring 13 in the locating groove 12 of the cap member 1, and then sleeve the spring member 23 onto the fastening shank 22 of the locking member 2, and then insert the locking member 2 and the spring member 23 into the open chamber 30 of the mounting socket 3 to stop the spring member 23 against the shoulder 302 and to force the expandable stop ring 13 against the beveled top edge 311 of the top mounting flange 31 of the mounting socket 3. At this time, the expandable stop ring 13 will be forced to expand and to move over the beveled top edge 311 to the bottom side of the horizontal bottom edge 312, enabling the locking member 2 and the cap member 1 to be axially movably secured to the mounting socket 3, and the spring member 23 to be kept in between the cap member 1 are and the mounting socket 3.

As the beveled top edge 311 of the top mounting flange 31 of the mounting socket 3 slopes downwards, forcing the expandable stop ring 13 downwardly against the beveled top edge 311 of the top mounting flange 31 will cause the expandable stop ring 13 to expand. After having passed over the beveled top edge 311 of the top mounting flange 31, the beveled top edge 311 immediately returns to its former shape and becomes stopped below the horizontal bottom edge 312 of the top mounting flange 31. Thus, coupling the cap member 1 to the mounting socket 3 does not cause the cap member 1 to expand or to stretch the mounting socket 3, avoiding vibration of the mounting socket 3 or disconnection of the mounting socket 3 from the first plate member 4. Further, the cap member 1 can be made of metal. Alternatively, the cap member 1 can be made from an insulative material, such as plastics, rubber or silicon rubber. Because it is not necessary to make any longitudinal crevices on the cap member 1 to facilitate mounting, the structural strength of the cap member 1 is maintained intact, avoiding deformation.

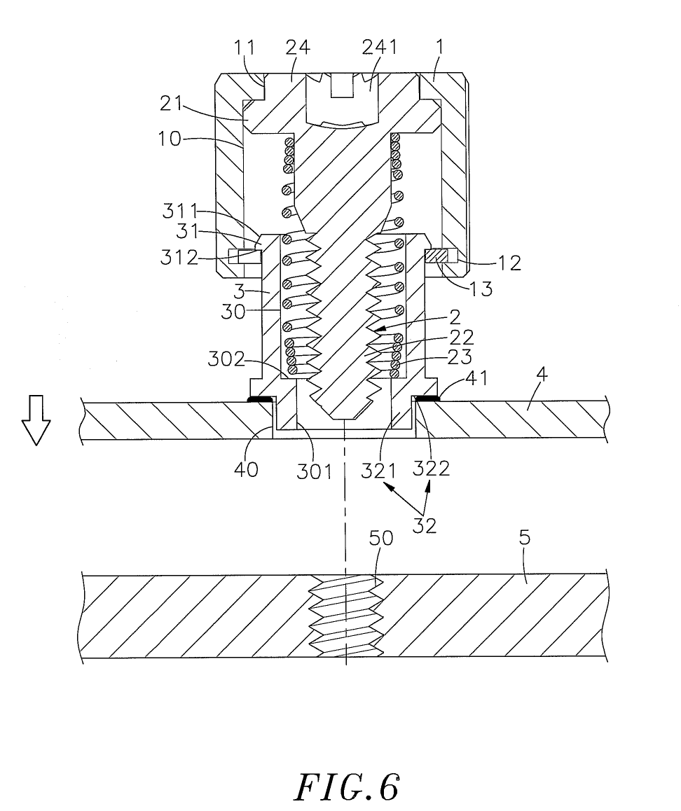

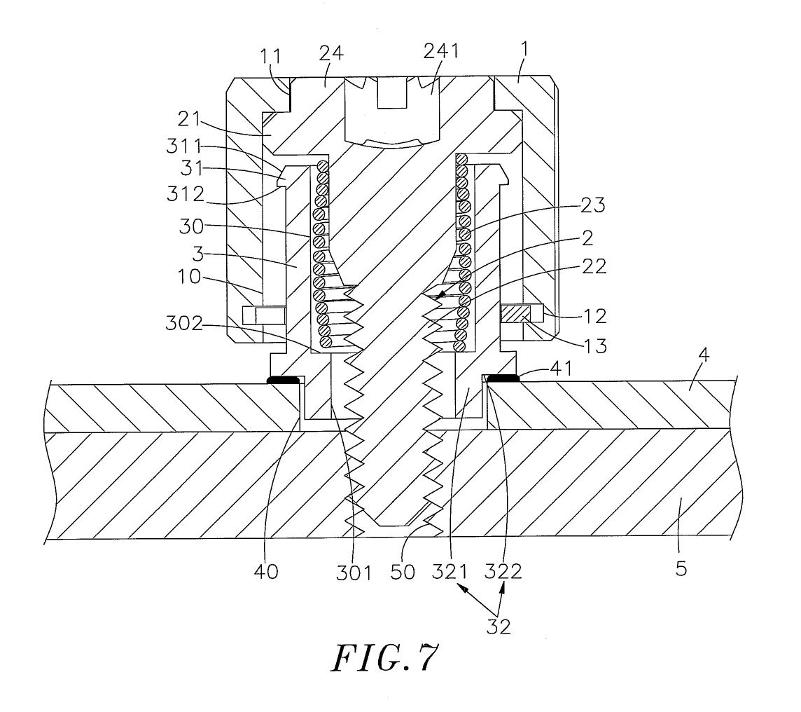

Referring to FIGS. 6 and 7 and FIGS. 2 and 3 again, when fastening the first plate member 4 to a second plate member 5, attach the first plate member 4 to the second plate member 5 to keep the mounting through hole 40 of the first metal plate member 4 in axial alignment with a corresponding mounting hole 50 on the second metal plate member 5, and then drive the fastening shank 22 of the locking member 2 into the mounting hole 50 of the second metal plate member 5 to lock the first metal plate member 4 and the second metal plate member 5 together.

The above described embodiment of the invention is simply for easy understanding of the spirit and scope of the invention but not intended as limitations of the invention. In general, the invention provides a floating fastener, which comprises a mounting socket 3 bonded to a first plate member 4 and having a beveled top mounting flange 31, a cap member 1 axially slidably coupled to the mounting socket 3, a locking member 2 fastened to the inside of the cap member 1, a spring member 23 sleeved onto the fastening shank 22 of the locking member 2 and stopped between the head 21 of the locking member 2 and a shoulder 302 inside the mounting socket 3, and an expandable stop ring 13 mounted in a locating groove 12 in the bottom side of the cap member 1 for enabling the cap member 1 to be coupled to the mounting socket 3 easily without causing vibration of the mounting socket 3 or disconnection of the mounting socket 3 from the first plate member 4.

In actual application, the floating fastener has the advantages as follows:
1. The expandable stop ring 13 is mounted in the locating groove 12 of the cap member 1. When coupling the cap member 1 to the mounting socket 3, the expandable stop ring 13 will be forced to expand and to move over the beveled top edge 311 of the top mounting flange 31 of the mounting socket 3 to the bottom side of the horizontal bottom edge 312, enabling the locking member 2 and the cap member 1 to be axially movably secured to the mounting socket 3 without causing vibration of the mounting socket 3 relative to the first plate member 4.
2. When coupling the cap member 1 to the mounting socket 3, the expandable stop ring 13 will be forced to expand in the locating groove 12 of the cap member 1 and to move over the beveled top edge 311 of the top mounting flange 31 of the mounting socket 3 to the bottom side of the horizontal bottom edge 312, avoiding deformation or breaking of the cap member 1.
3. The cap member 1 can be made from plastics or metal without any longitudinal crevices to facilitate mounting. Therefore, the structural strength of the cap member 1 is maintained intact, avoiding deformation.

It is to be understood that the above-described preferred embodiment of the invention is merely an example of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A floating fastener, comprising:
a mounting socket, said mounting socket comprising a top mounting flange extending around the periphery of a top side thereof, a bottom mounting unit bonded to a first plate member and a shoulder defined in said bottom mounting unit;
a cap member axially slidably coupled to said mounting socket, said cap member comprising a bottom-open accommodation chamber having a bottom open side, a coupling hole cut through a top wall thereof in communication with said bottom-open accommodation chamber, and a locating groove extending around an inside wall thereof near the bottom open side of said bottom-open accommodation chamber;
an expandable stop ring mounted in said locating groove of said cap member and adapted for stopping at a bottom side of said top mounting flange of said mounting socket;
a locking member having a head, a tool-driving block upwardly protruded from said head and fixedly mounted in said coupling hole of said cap member and a fastening shank downwardly extended from said head and adapted for fastening to said second plate member to lock said first plate member to said second plate member; and
a spring member sleeved onto said locking member and stopped between said head of said locking member and said shoulder of said mounting socket.

2. The floating fastener as claimed in claim 1, wherein said cap member is made of metal.

3. The floating fastener as claimed in claim 1, wherein said cap member is made from an insulative material selected from a group consisting of plastics, rubber and silicon rubber.

4. The floating fastener as claimed in claim 1, wherein said locking member comprises an engagement portion extending around the periphery of said head.

5. The floating fastener as claimed in claim 4, wherein said engagement portion comprises a plurality of teeth, ribs and/or raised spots.

6. The floating fastener as claimed in claim 1, wherein said tool-driving block of said locking member defines therein a tool-driving groove.

7. The floating fastener as claimed in claim 1, wherein said top mounting flange of said mounting socket has a beveled top edge and a horizontal bottom edge.
